(19) United States
(12) Patent Application Publication
(10) Pub. No.: US 2023/0075142 A1
(43) Pub. Date: Mar. 9, 2023

(54) BATTERY PACK INSULATION SUPPORT

(71) Applicant: Rivian IP Holdings, LLC, Irvine, CA (US)

(72) Inventors: Bruce Philip Edwards, Menlo Park, CA (US); Edward Djrbashian, Glendale, CA (US); Kyle Butterfield, Ladera Ranch, CA (US); Casey Dunn, Mission Viejo, CA (US); Ehsan Baseri, Irvine, CA (US)

(21) Appl. No.: 17/866,238

(22) Filed: Jul. 15, 2022

Related U.S. Application Data
(60) Provisional application No. 63/240,667, filed on Sep. 3, 2021.

(51) Int. Cl. H01M 10/653; H01M 50/502; B60L 50/64; H01M 10/6561; H01M 50/593

(52) U.S. Cl. CPC H01M 10/653; H01M 50/502; B60L 50/64; H01M 10/6561; H01M 50/593; H01M 2220/20

(57) ABSTRACT

Example illustrations are directed to an insulator assembly and methods, e.g., of installing the insulator assembly into a battery pack. An insulator assembly may include an insulator sheet and an insulator sheet standoff coupled to the insulator sheet. The standoff may be configured to allow ventilation associated with the insulator sheet and one or more surfaces of a battery component. Example insulator assemblies may be provided in a battery pack, e.g., for an electric vehicle.

### CROSS-REFERENCE TO RELATED APPLICATION

The present application claims priority to U.S. Provisional Patent Application No. 63/240,667, filed on Sep. 3, 2021, the contents of which are hereby expressly incorporated by reference in their entirety.

### INTRODUCTION

The present disclosure relates to battery packs such as for an electric vehicle, and more particularly to insulation systems for a battery pack.

### SUMMARY

Battery packs for an electric vehicle generally must carry a significant electrical potential to provide adequate power and range for the vehicle. Battery packs may have electrical and thermal insulation to isolate the electrical potential and prevent propagation of thermal events in the pack or battery modules within. However, insulation can also interfere with battery pack venting, and as a result may prevent gas or pressure from a thermal event of a battery module or cell from being vented out of the battery pack. Insulation may instead push hot gas back into a venting module and/or to neighboring battery cells. Accordingly, there is a need for an improved battery pack system that provides electrical and thermal insulation.

In at least some example illustrations, an insulator assembly is provided comprising an insulator sheet and an insulator sheet standoff coupled to the insulator sheet. The standoff may be configured to allow ventilation associated with the insulator sheet and one or more surfaces of a battery component.

In some examples, the battery component is a battery module, and the insulator sheet is spaced from the one or more surfaces of the battery module by the insulator sheet standoff to define a vent flow path therebetween.

A standoff may be, in at least some examples, a compliant member configured to support the insulator sheet away from the one or more surfaces of the battery component in a compressed state. For example, the compliant member may include a foam material.

In at least some example approaches, the standoff is an electrical component of a bus bar configured to electrically connect the battery component to an electrical load of a vehicle. In at least a subset of these examples, the insulator sheet is configured to be aligned vertically in between opposing surfaces of two battery components.

In at least some example approaches, the standoff is configured to support the insulator sheet against a backing layer. For example, the backing layer may be a cover of a battery pack containing the battery component. In another example, the backing layer may be a metallic layer of a laminated bus bar assembly configured to electrically connect the battery component to an electrical load of a vehicle.

In at least some examples, the standoff is coupled to the insulator sheet with an adhesive.

In at least some examples, the insulator sheet comprises any one or more of nickel, steel, a high temperature mineral, and mica.

In other example approaches, a battery pack for an electric vehicle is provided that includes a pack housing comprising a battery component. The battery pack may also include an insulator sheet positioned between the battery component and the pack housing, and an insulator sheet standoff coupled to the insulator sheet. The standoff may be configured to allow ventilation associated with the insulator sheet and one or more surfaces of a battery component.

In at least some example battery packs, the battery component is a battery module, and the insulator sheet is spaced from the one or more surfaces of the battery module by the insulator sheet standoff to define a vent flow path therebetween.

In at least some example battery packs, the insulator sheet is a first insulator sheet, and further comprising a second insulator sheet layered with the first insulator sheet in a laminated bus bar assembly. For example, the first insulator sheet may be positioned above a first battery component, and the second insulator sheet is arranged above a second battery component, the second insulator sheet adjacent a cover of the battery pack housing.

In at least some example battery packs, a plurality of insulator sheets are arranged in a vertical orientation between a plurality of battery components.

In at least some example illustrations, a method of assembling a battery pack for an electric vehicle comprises providing a pack housing comprising a battery component. The method also includes positioning an insulator sheet between the battery component and the pack housing. The method also includes enclosing the pack such that one or more insulator sheet standoffs coupled to the insulator sheet support the insulator sheet away from one or more battery components to provide a vent flow path therebetween.

In at least some example methods, the battery component is a battery module, and positioning the insulator sheet between the one or more battery modules and the pack housing forms a vent flow path with the insulator sheet and the one or more surfaces of the battery module, the vent flow path extending between the insulator sheet and the one or more surfaces of the battery module.

In at least some example methods, a plurality of insulator sheets are arranged in a vertical orientation between a plurality of battery components.

In at least some example illustrations, a battery pack for an electric vehicle is provided comprising a pack housing having a plurality of battery components defining an aisle extending between opposing surfaces of the battery components. The battery pack may include a plurality of insulator sheets, arranged in a vertical direction between the opposing surfaces of the battery components, wherein the insulator sheets are positioned to allow ventilation from the battery modules defining the aisle.

### BRIEF DESCRIPTION OF THE DRAWINGS

The above and other features of the present disclosure, its nature and various advantages will be more apparent upon consideration of the following detailed description, taken in conjunction with the accompanying drawings in which:

FIG. 1 is a plan view of a battery pack, e.g., for an electric vehicle, according to an example approach;

FIG. 2 is a right-side rear upper perspective view of the battery pack of FIG. 1 with a cover, according to one example;

FIG. 3 is a front lower perspective view of the battery pack of FIGS. 1 and 2 illustrating a floor structure, according to an example;

FIG. 4 is a left-side front upper perspective view of the battery pack of FIGS. 1-3 with the cover removed to reveal module bays of the pack, according to an example;

FIG. 5 is a left-side rear upper perspective view of an assembly of battery modules and insulator sheets for the battery pack of FIGS. 1-4, according to an example approach;

FIG. 6 is an upper perspective view of the battery pack of FIGS. 1-5 with the assembly of battery modules and insulator sheets of FIG. 5 installed therein, according to one example;

FIG. 7 is a lower front perspective view of the battery pack of FIGS. 1-5 with battery modules removed to illustrate insulator sheets of the battery pack with standoffs for a battery module, according to an example;

FIG. 8 is an upper front perspective view of the battery pack of FIGS. 1-5 to illustrate insulator sheets of the battery pack in a bus bar area of the battery module, according to an example approach;

FIG. 9 is a lower front perspective view of an insulator sheet of the battery pack of FIGS. 1-5 to illustrate standoffs of the insulator sheet, according to an example approach;

FIG. 10 is a top perspective view of the battery pack of FIGS. 1-5 with the battery modules of FIG. 5 installed therein, as well as insulator sheets positioned between the battery modules, according to one example;

FIG. 11 is a left rear upper perspective view of the insulator sheets of FIG. 10 in an installed position between bus bar contacts of the battery pack, in which the insulator sheets are shown without the battery modules and pack housing, according to an example;

FIGS. 12 is an illustration of an example process of assembling the battery pack and insulator sheets illustrated in FIGS. 1-11, which shows an insulator sheet having standoffs prior to installation to a backing layer;

FIG. 13 is another illustration of an example process of assembling the battery pack and insulator sheets illustrated in FIGS. 1-11, which shows the insulator sheet of FIG. 12 being installed to the backing layer;

FIG. 14 is another illustration of an example process of assembling the battery pack and insulator sheets illustrated in FIGS. 1-11, which shows the insulator sheet and standoffs after being installed to the backing layer;

FIG. 15 is another illustration of an example process of assembling the battery pack and insulator sheets illustrated in FIGS. 1-11, which shows another insulator sheet being installed to a laminated busbar support layer;

FIG. 16 is another illustration of an example process of assembling the battery pack and insulator sheets illustrated in FIGS. 1-11, which shows the insulator sheet of FIG. 15 after being installed to the laminated busbar support layer;

FIG. 17 is another illustration of an example process of assembling the battery pack and insulator sheets illustrated in FIGS. 1-11, which shows a laminated busbar assembly being installed over the insulator sheet of FIGS. 15 and 16, thereby sandwiching the insulator sheet of FIGS. 15 and 16 between the laminated busbar support layer and the laminated busbar assembly;

FIG. 18 is another illustration of an example process of assembling the battery pack and insulator sheets illustrated in FIGS. 1-11, which shows the laminated busbar assembly of FIG. 17 after being installed over the insulator sheet of FIGS. 15 and 16;

FIG. 19 is another illustration of an example process of assembling the battery pack and insulator sheets illustrated in FIGS. 1-11, which shows an upper insulator sheet being installed over the laminated busbar assembly of FIGS. 17 and 18;

FIG. 20 is another illustration of an example process of assembling the battery pack and insulator sheets illustrated in FIGS. 1-11, which shows an enlarged portion of FIG. 19 after installation of the upper insulator sheet of FIG. 19 to the laminated busbar assembly of FIGS. 17 and 18, illustrating alignment of locating apertures of the upper insulator sheet with studs of the laminated busbar assembly;

FIG. 21 is another illustration of an example process of assembling the battery pack and insulator sheets illustrated in FIGS. 1-11, which shows the upper insulator sheet of FIGS. 19 and 20 with fastener nuts being installed to secure the upper insulator sheet to the laminated busbar assembly of FIGS. 17 and 18;

FIG. 22 is another illustration of an example process of assembling the battery pack and insulator sheets illustrated in FIGS. 1-11, which shows insulating nut covers being installed over the fastener nuts of FIG. 21;

FIG. 23 is a section view of the battery pack of FIGS. 1-5 taken through line 23-23 of FIG. 1 illustrating example standoffs for an insulator sheet, according to an example approach; and

FIG. 24 is a process flow diagram for an example method of assembling a battery pack and insulator sheets, according to an example.

### DETAILED DESCRIPTION

Example illustrations herein are directed to a battery pack, e.g., for an electric vehicle, having a plurality of battery modules, in which battery cells are provided for providing electrical power. The battery modules/cells may, in some examples, be electrically tied together by a laminated bus bar assembly, which facilitates application of a collective electrical potential of the battery modules to electrical loads of the vehicle, e.g., one or more high-voltage motors configured to provide vehicle propulsion. The battery pack may include insulator sheets within the pack in various locations to provide thermal and/or electrical insulation of the battery pack and/or between various components of the battery pack. In some examples, insulator sheets are formed of a mica material, i.e., a silicate mineral with a layered structure. Nickel, steel, and/or a high temperature mineral such as mica may be employed in some insulator sheet examples. Further, in some example insulator sheets two or more of nickel, steel, and/or a high temperature mineral such as mica may be employed.

Example insulator sheets may be provided in any number and configuration that is convenient. In an example approach, an insulator sheet is located in a front portion of the battery pack. Additional insulator sheets may be positioned in a layered assembly of multiple insulator sheets with a bus bar of the battery pack, with the assembly positioned between battery components, e.g., battery modules, and a cover of the battery pack. A further insulator sheet assembly may be provided underneath a cover of the pack, above the battery components, with one or more standoffs configured to allow gases from battery modules to vent from the battery pack if a thermal even occurs. Insulator sheets may also be positioned vertically between battery modules of the pack, e.g., along an “aisle” of the battery modules within the pack, to reduce the potential for an electrical arc across the aisle. Further, the vertical insulator sheets may also help fit battery modules within the battery pack as they are placed into bays of the battery pack.

In example approaches herein, standoffs may be assembled to or around insulator sheets to increase durability, making the insulator sheets more resistant to shock and vibration that the battery pack may be subjected to, which may be particularly advantageous to the extent the vehicle is targeted to off-road applications. There may also be cutouts in the Mica sheets to allow for structural elements to be bolted to the pack (such as the seat structure) or to save overall weight while maximizing coverage of Mica.

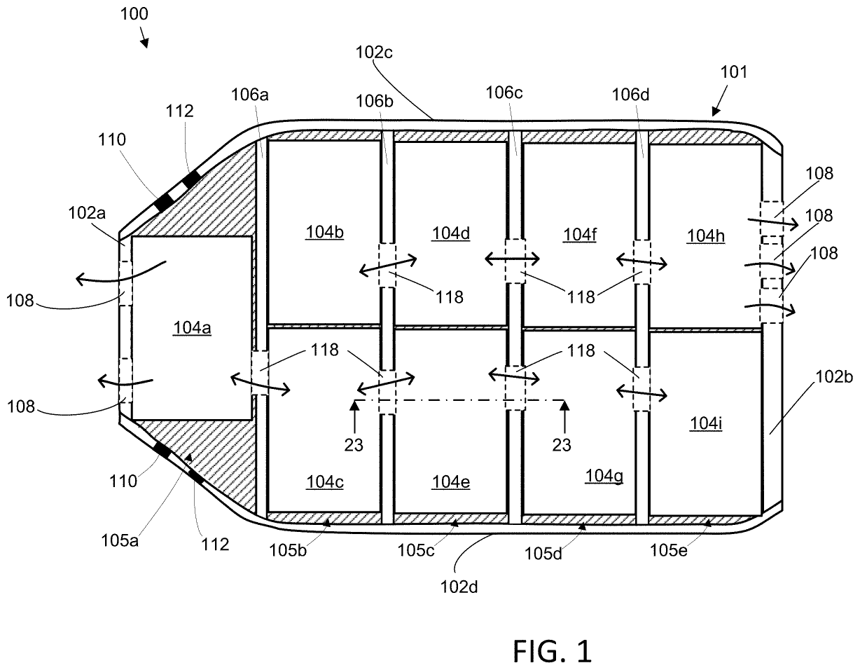

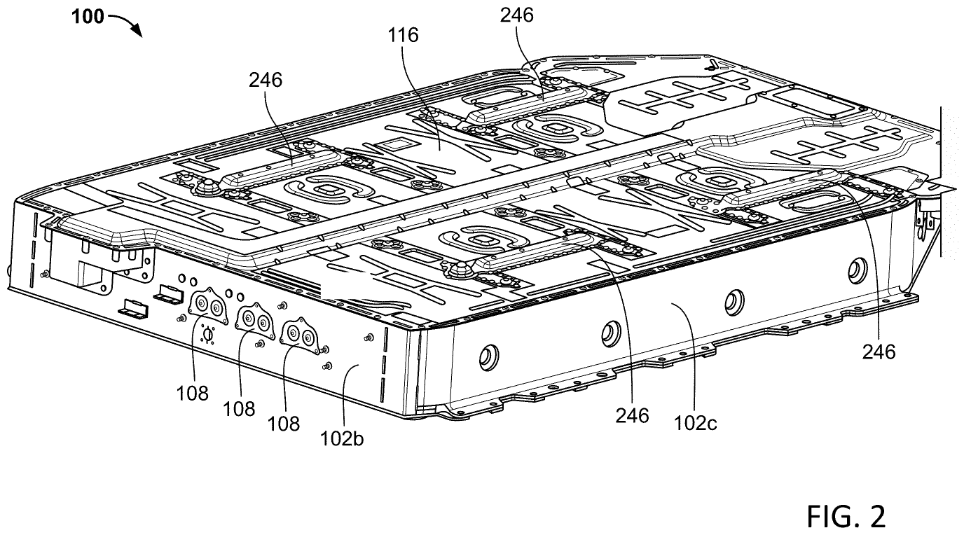

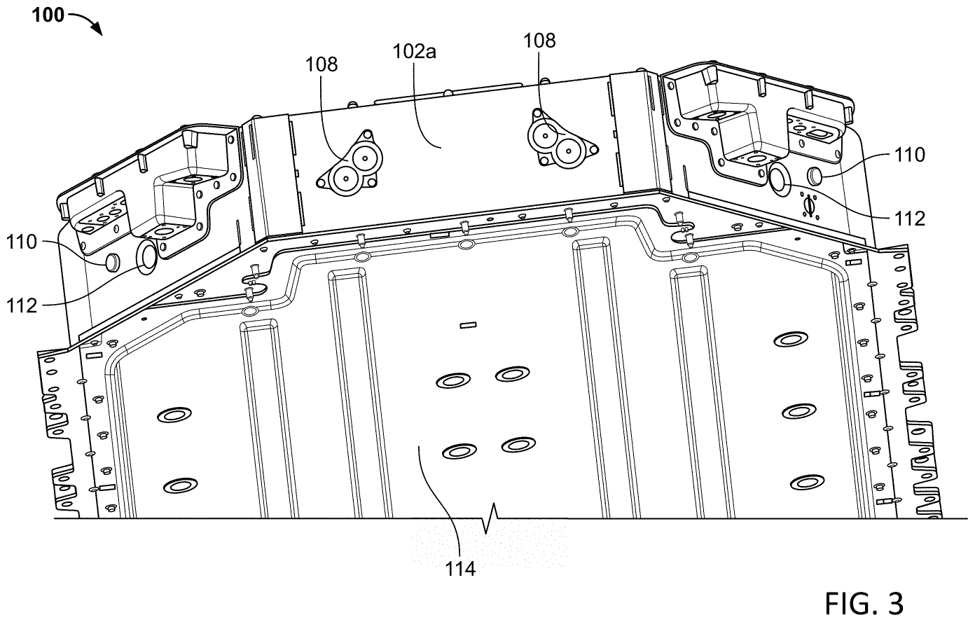

Referring now to FIGS. 1-5, an example battery pack or assembly 100 is shown, which may generally represent an example embodiment of the systems and methods described herein. As shown in FIG. 1, the battery pack 100 may be enclosed by wall assemblies 102a, 102b, 102c, and 102d (collectively, 102) extending about a perimeter of the battery pack 100. The battery pack 100 encloses battery components such as the modules 104a, 104b, 104c, 104d, 104e, 104f, 104g, 104h, and 104i (collectively, 104), which collectively provide power to an electric vehicle for propulsion. The wall assemblies 102a, 102b, 102c, and 102d form a housing 101. The battery modules 104 are enclosed within module bays 105a, 105b, 105c, 105d, and 105e (collectively, 105), which are defined by the wall assemblies 102 and cross members 106a, 106b, 106c, and 106d (collectively, 106). The cross members 106 each extend laterally along the battery pack 100 between the wall assemblies 102c and 102d. A floor structure 114 (see FIG. 3) provides a bottom support or surface of the battery pack 100, upon which battery cells, electronics, and the like may be supported above. A cover 116 (see FIG. 2) may enclose the module bays 105 from above.

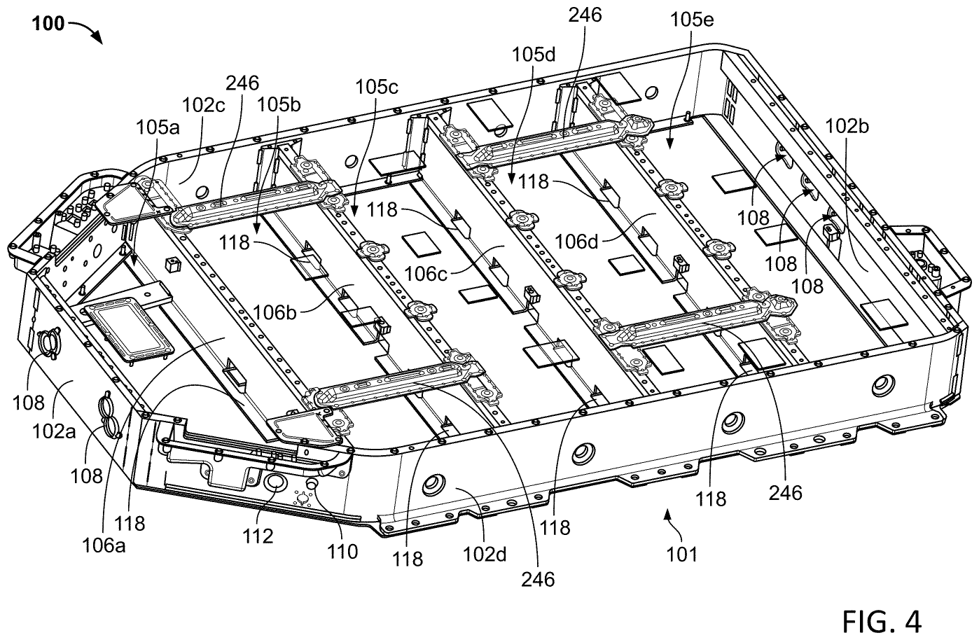

Generally, the battery pack 100 may be substantially sealed such that fluid flow into and out of the enclosure defined by the housing 101 and/or wall assemblies 102, e.g., of ambient air, is limited to specific venting flow paths. In the example illustrated, venting flow paths are provided by pressure relief valves 108, plug valves 110, and deformable valves 112. The valves 108, 110, and 112 are generally configured to handle different levels of pressure/flow from the battery pack 100 to the external environment. More specifically, the plug valves 110 (see also FIGS. 3 and 4) may facilitate relatively low-pressure flows to and from the battery pack 100, e.g., which may occur due to thermal expansion/contraction of air within the battery pack 100. The plug valves 110 may be a generally solid plug of permeable material configured to permit a maximum level of flow that is relatively low, consistent with thermal expansion/contraction of the battery pack 100. By contrast, the pressure relief valves 108 are configured to facilitate one-way flow out of the battery pack 100 in response to relatively greater thermal or pressure flows, e.g., due to venting of battery cells in one or more of the module bays 105. The pressure relief valves 108 may each include moveable valve members, such as an umbrella valve, which are configured to provide one-way flow out of the battery pack 100, while sealing against intrusion of water or other contaminants. As shown in FIG. 1, the battery pack 100 includes multiple pressure-relief valves 108, with two provided the in the forward end wall assembly 102a and three located in a rearward wall assembly 102b. In further contrast to the plug valves 110 and pressure relief valves 108, the deformable valves 112 (see also FIGS. 3 and 4) may facilitate a relatively greater flow of pressure or heat from the battery pack 100, e.g., due to a sudden or extreme thermal event of one or more battery cells. The deformable valves 112 may include a deformable disc or other structure that is configured to break or disintegrate in response to a pressure or temperature above a predetermined amount, e.g., as may be characteristic of a thermal event of battery cells in the pack 100.

The battery pack 100 may be configured to vent from within the pack 100 to the external environment in response to different levels or thresholds of internal pressure or heat corresponding to the different fluid flow paths provided by the different valves 108, 110, and 112. In some examples, a pressure buildup or flow exceeding a predetermined amount, e.g., above 10 kPa, may generate a warning for service of battery pack 100. For example, control circuitry may be arranged within battery pack 100 which comprises sensors (e.g., a water sensor configured to detect standing water within the battery pack assembly, a temperature sensor, a voltage sensor, and a pressure sensor). These sensors may be configured to provide data and warnings to a vehicle operator, a vehicle controller, or the like.

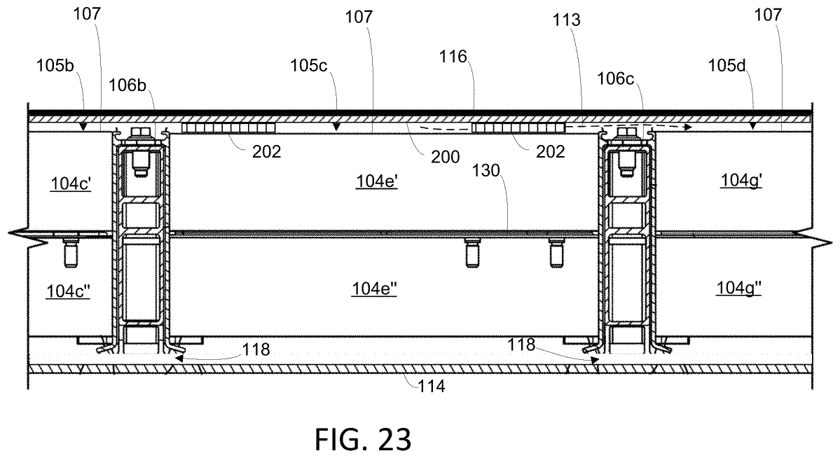

Referring again to FIGS. 1-5, as noted above the battery pack 100 is generally sealed, apart from the fluid flows permitted by the valves 108, 110, and 112 to address increases of pressure and/or temperature within the wall assembly 102. As shown in FIG. 1, the wall assembly 102 and cross members 106 of the battery pack 100 generally may create enclosures or bays 105 around the battery cell modules 104. While nine modules 104 are illustrated being distributed amongst five bays 105, any number of modules 104 or bays 105 may be employed that are convenient. Battery modules 104a-i may be comprised of a plurality of battery cells that are interconnected to generate an amount of electrical energy to be provided to a larger vehicle system, e.g., by way of a bus bar or terminal(s). Battery modules 104a-i may be arranged vertically, horizontally, or may be stacked over each other depending on the available packing space of the structure for which the battery pack 100 is configured to provide electrical power. In an example, battery modules 104 within one or more of the module bays 105, and in some cases each of the bays 105, are positioned in a two-layer stack of battery cells. More specifically, as illustrated in FIG. 23, a lower submodule 104e″ may be positioned beneath an upper submodules 104e′, with a cooling apparatus or layer 130 positioned between. The layer of cells within the upper submodule 104e′ may be positioned to vent upwardly toward the cover 116, while the lower layer of cells within the lower submodule 104e″ are positioned to vent downwardly toward the floor structure 114. Accordingly, the battery cells in the lower submodule 104e″ may generally vent toward floor structure 114, which redirects the flow to the pressure relief valves 108 at the front and rear of the battery pack 100 via one or more bidirectional vent passages 118. In the example illustrated in FIG. 23, an insulator sheet 200 is provided which is supported against a backing layer, e.g., cover 116, by one or more standoffs 202. The standoffs 202 may generally position and support the insulator sheet 200 away from the module(s) 104, thereby providing a space adjacent the modules 104 for a venting path of the modules 104 or battery cells thereof. The upper submodule 104e′ (and, for that matter, other upper submodules 104′) may vent through open air clearances between the module bays 105. More specifically, a venting clearance may be maintained between the upper submodules 104′ and the cover 116. Accordingly, venting from the bay 105 may occur by way of the clearance between the upper submodules 104′ and the cover 116, as well as by way of the multidirectional venting passage(s) 118. The multidirectional venting passages 118 may advantageously open additional venting flowpath(s) from the bay 105, which would otherwise be blocked off due to the cross member 106 meeting the floor structure 114. In some examples it may also be possible for the battery cells in the upper submodule 104e′ to vent, at least partially, by way of the bidirectional vent passages 118. For example, some of the vent flow may be redirected towards and around the sides of the battery module 104 by the insulator sheet 200, eventually flowing to pressure relief valves 108 at the front and rear of the battery pack 100, e.g., via the bidirectional vent passages 118.

The bays 105 of the battery pack 100 may permit fluid communication via one or more defined flow paths, e.g., as described above and illustrated in FIG. 23, to permit flow of pressure or fluid to the valves 108, 110, and/or 112 for venting. For example, as shown in FIGS. 1, 3 and 23, vent passages 118 may be provided along floor structure 114 of the battery pack 100, facilitating ventilation of downward-facing submodules 104″ to each of the bays 105 of the battery pack 100. Additionally, upward-facing submodules 104′ of the battery pack 100 may vent via space for ventilation created by the standoffs 202, e.g., towards and around the sides of the submodules 104′ to pressure relief valves 108 as noted above. The forwardmost module bay 105a may vent to the external environment via the pressure relief valves 108, and the rearward-most module bays 105h and 105i each may vent to the external environment via their respective pressure-relief valves 108. Accordingly, a thermal event or cell venting event in any of the bays 105 may be communicated to adjacent bays 105 of the battery pack 100. Further, to the extent this may cause a buildup of pressure within the module bays 105 collectively, the pressure relief valves 108 and deformable valves 112 may collectively vent the excess pressure to the external environment.

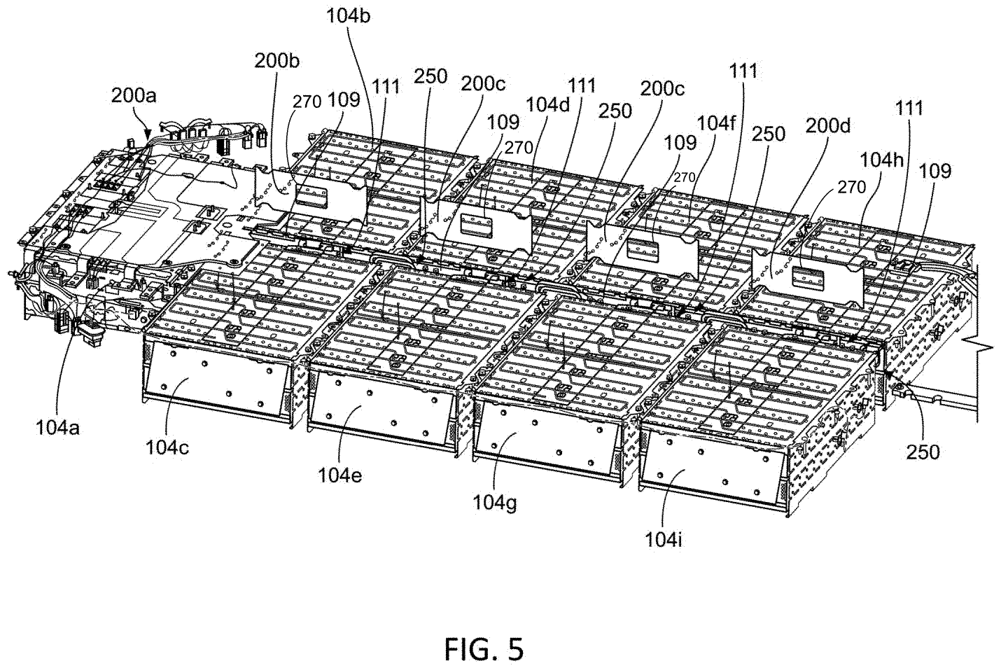

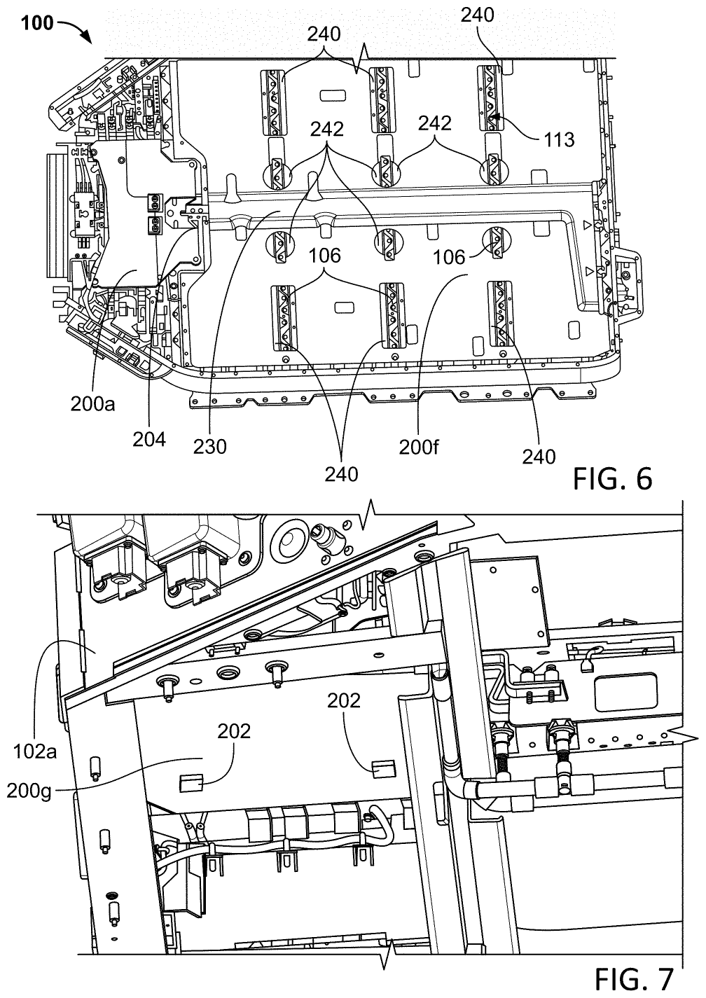

Turning now to FIGS. 5-8, example insulator sheets 200 of the battery pack 100 are illustrated and described in further detail. As noted above, the battery pack 100 includes a plurality of modules 104, which are electrically tied together via a bus bar 204. The battery pack 100 may have an insulator sheet assembly 200a having a plurality of insulator sheets adjacent a forward end of the bus bar 204. The battery pack 100 may also include insulator sheets 200b, 200c, 200d, and 200e in a vertical orientation when installed in the battery pack 100. As will be described further below, vertically oriented insulator sheets 200b-200e may be positioned by bus bar contacts or terminals 206. Another insulator sheet 200f may be provided above a rearward or main portion of the battery pack, above modules 104b-104i (see FIG. 6). Additionally, one or more of the modules 104, or all of the modules 104, may have insulator sheets 200g, which may be positioned directly above the module(s) 104 via standoffs 202, e.g., as shown in FIG. 23. Standoffs 202 may be coupled to insulator sheets, e.g., insulator sheet 200g, to allow ventilation associated with the insulator sheet and one or more surfaces of the battery module 104. For example, the standoffs 202 may generally space an insulator sheet from an adjacent battery module 104, thereby providing a vent flow path between the insulator sheet and the battery module 104.

Generally, insulator sheets 200 may be formed of a mica material, which is relatively brittle. Example standoffs 202 and other supports, e.g., via bus bar terminals 206, may generally support insulator sheets 200 to maintain the insulator sheets 200 in a desired position to facilitate venting and prevent the insulator sheets 200 from being dislodged or breaking. In some example approaches, standoffs 202 or bus bar terminals 206 may position insulator sheet(s) 200 against a backing layer which generally supports the insulator sheet 200 in a thermal event. The insulator sheets 200 may thereby provide electrical and thermal insulation of components within the battery pack 100, reducing the likelihood of electrical arcing from one or more of modules 104.

In the example insulator sheet 200g illustrated in FIG. 7, standoffs 202 may be formed of a compliant or compressible material, e.g., a foam material or the like. The standoffs 202 may be secured to the insulator sheet 200g, e.g., with an adhesive. The standoffs 202 may be resilient or compliant such that the standoff(s) 202 become compressed slightly against the module(s) 104 when installed into the battery pack 100, e.g., due to weight of a backing layer (not shown in FIG. 7), cover 116, or other components of the battery pack 100 that may result in some weight or pressure applied downwardly, thereby compressing the standoffs 202 against the module(s) 104 (not shown in FIG. 7). In an example, the standoffs 202 are a foam material that is configured to be compressed from 5% to a maximum of 60% without loss of support or resilience of the standoffs 202. Merely as examples, polyurethane-based and silicone-based foams may be employed. Foam material(s) employed in/as standoffs 202 may also have thermal and electrical insulating properties, as may be advantageous to the extent the standoffs 202 are adjacent or in contact with battery components such as battery modules 104 (not shown in FIG. 7). Further, compressible standoffs such as standoffs 202 may provide a resilient support of the insulator sheet 200g creating a space for venting between the insulator sheet 200g and an adjacent battery module 104. Additionally, the insulator sheet 200g is supported during a thermal event causing significant venting, heat, or pressure against the insulator sheet 200g, reducing the likelihood of pressure or gas “blowing through” the insulator sheet 200g.

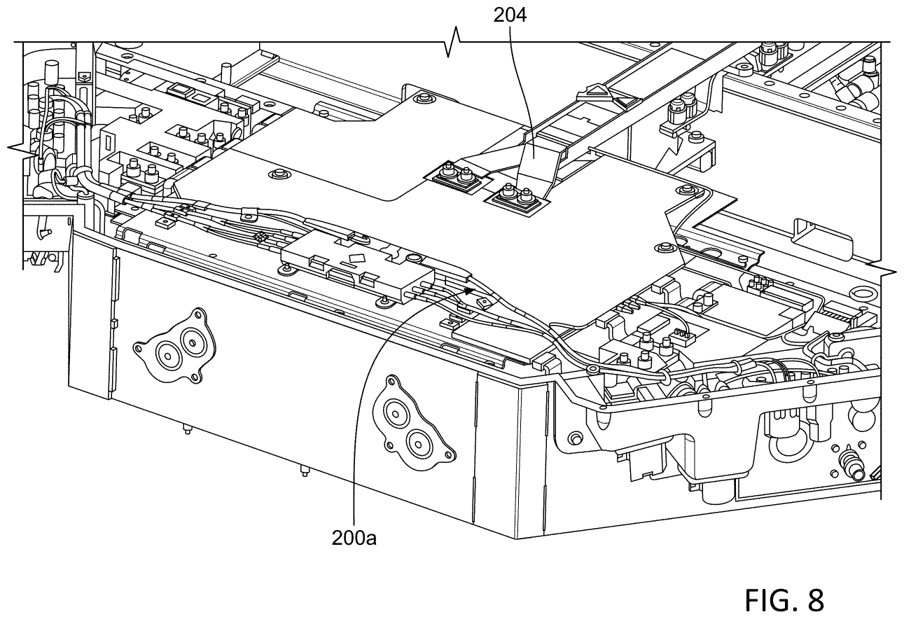

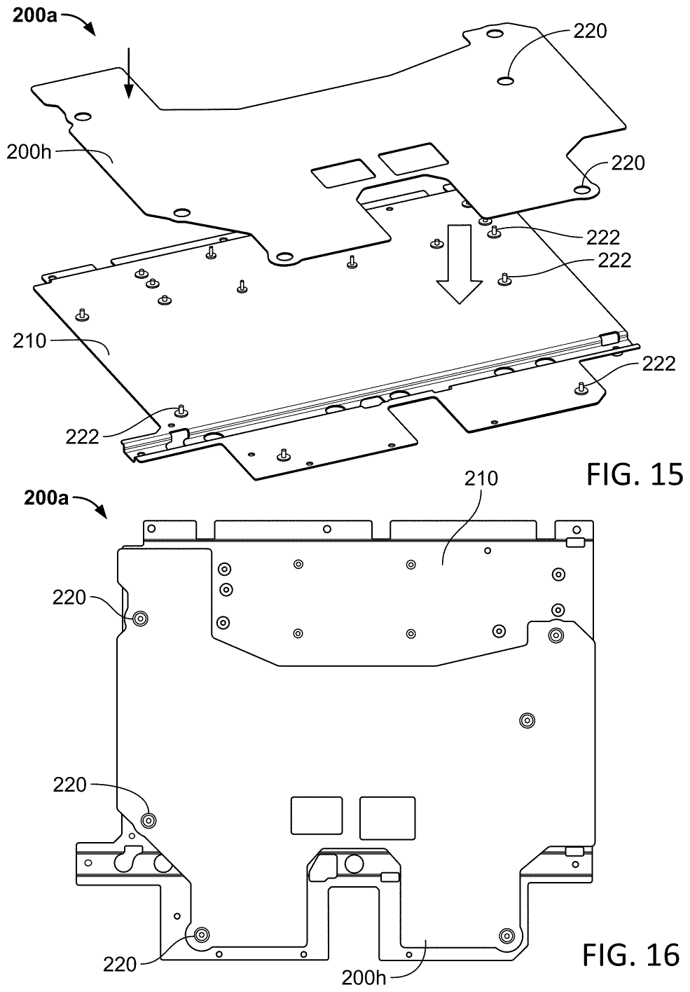

Turning now to FIGS. 6 and 8, in the example battery pack 100 a plurality of insulator sheets may be provided in a layered insulator sheet assembly 200a. As will be described further below, the insulator sheet assembly 200a may be configured to thermally and/or electrically insulate components of a laminated bus bar assembly 204 that is configured to electrically connect one, a plurality of, or all of the battery modules 104 of the battery pack 100. More specifically, as will be described further below and as shown in FIGS. 15-22, the sheet assembly 200a may include a metallic base layer 210, a first insulator sheet 200h, a laminated sheet conductor assembly 204′, and a second insulator sheet 200i.

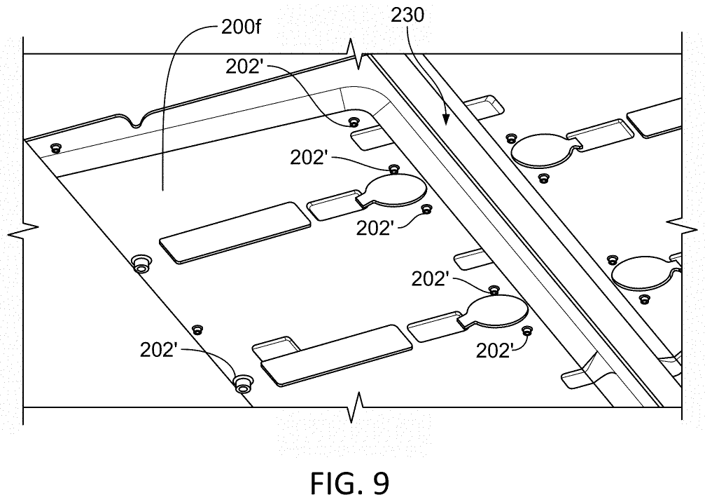

Referring now to FIGS. 6 and 9, the example battery pack 100 may also include an insulator sheet 200f configured to be positioned over a plurality of the battery modules 104. More particularly, the insulator sheet 200f is arranged to generally cover a rear portion of the battery pack 100, including the battery modules 104b, 104c, 104d, 104e, 104f, 104g, 104h, and 104i (see FIG. 5). The insulator sheet 200f may include a plurality of standoffs 202′, as shown in FIG. 9. Generally, insulator sheets may cooperate with one or more surfaces of battery modules 104 to define a vent flow path between the insulator sheet and the module(s) 104. In the example illustrated in FIGS. 6 and 9, the insulator sheet 200f is spaced away from the battery modules 104b, 104c, 104d, 104e, 104f, 104g, 104h, and 104i by the standoffs 202′ (not shown in FIG. 6). Accordingly, the insulator sheet 200f cooperates with the surfaces of the modules 104b, 104c, 104d, 104e, 104f, 104g, 104h, and 104i to define a vent flow path 113. The vent flow path 113 may allow ventilation of cells within the modules 104b, 104c, 104d, 104e, 104f, 104g, 104h, and/or 104i in a direction generally upwards within the pack 100. For example, as noted above a vent path may allow ventilation towards and around the sides of the battery modules 104 to pressure relief valves 108. Additionally, the insulator sheet 200f includes a tunnel portion 230 configured to extend along at least a portion of the laminated bus bar 204 (see FIG. 6). The tunnel portion 230 may be positioned generally over an aisle defined by the battery modules 104b-104i. The insulator sheet 200f may thus be positioned between the bus bar 204 and the cover 116 when the cover 116 encloses the pack 100.

Example insulator sheets 200 may be provided with cutouts or other features to facilitate integration of structural members or supports of the battery pack 100 and/or an associated vehicle into which the battery pack 100 is installed. For example, as shown in FIG. 6, the insulator sheet 200f may include six elongated cutouts 240 and six circular cutouts 242, each of which allow access through the insulator sheet 200f to the cross members 106 of the battery pack 100. The cutouts may have any shape or configuration convenient. The cross members 106 may thus be structurally tied through the insulator sheet 200f to vehicle components or vehicle structures (not shown), e.g., as part of mounting points for seats or the like. The battery pack 100 may also have longitudinal reinforcements (i.e., extending generally perpendicularly with respect to the cross members 106), which may be secured to the top of the cover 116, e.g., via welding. For example, as shown in FIG. 2, four longitudinal members 246 may be secured through the cutouts 240 to the cross members 106 via bolts, welding, or the like. (See also FIG. 4, which illustrates the longitudinal members 246 and cross members 106 without the cover 116.) Additional lateral reinforcements (not shown) may be provided beneath the cover 116, e.g., to abut against the cross members 106 along the cutouts 240.

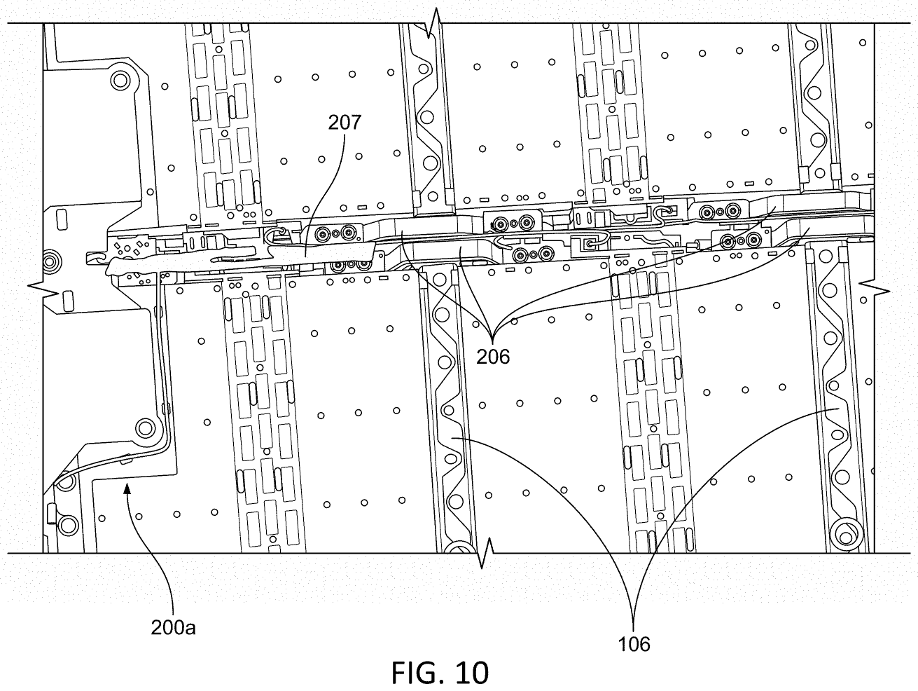

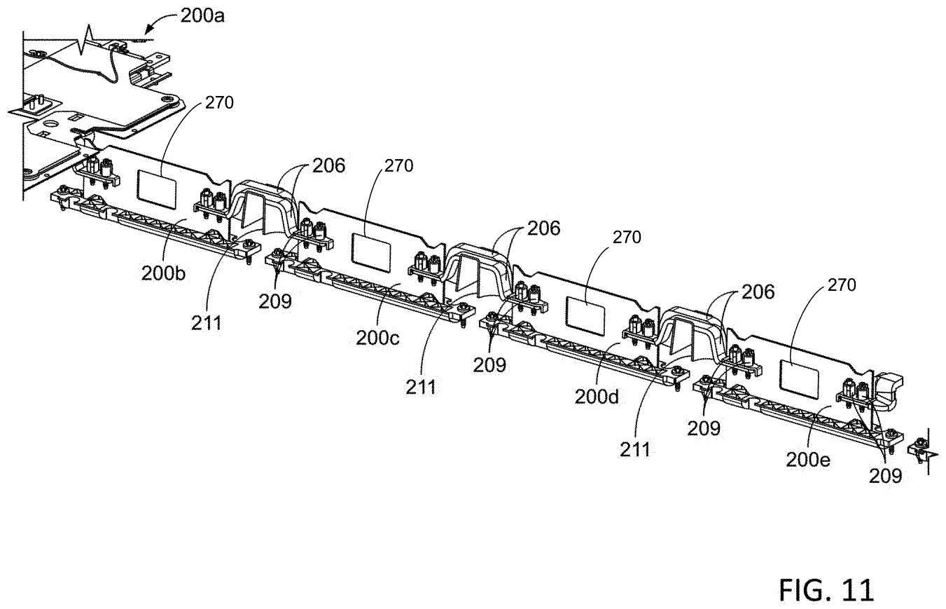

Referring now to FIGS. 5, 10, and 11, the battery pack 100 may include a plurality of insulator sheets 200b, 200c, 200d, and 200e configured to be positioned vertically within the pack 100. Each of the sheets 200b, 200c, 200d, and 200e may have an opening 270 in the center, which may serve to reduce overall weight of the sheets 200b, 200c, 200d, and 200e, e.g., in areas where there may be less need for protection. A plurality of bus bar contacts 206, as shown in FIGS. 10 and 11, may be electrical components configured to electrically connect one or more modules 104 of the pack, e.g., with the bus bar 204, and in turn with an electrical load of a vehicle, e.g., one or more electric motors for vehicle propulsion. The bus bar contacts 206 may be positioned in the pack 100 within an aisle 250 or longitudinal space extending between the battery modules 104. In the example illustrated, the aisle 250 is generally defined on a first side by battery modules 104b, 104d, 104f, and 104h and on a second side by battery modules 104c, 104e, 104g, and 104i. More particularly, the aisle 250 may be generally defined by surfaces 109 of the modules 104b, 104d, 104f, and 104h on one side of the aisle 250, and by surfaces 111 of the modules 104c, 104e, 104g, and 104i on a second/opposing side of the aisle 250. One side of the insulator sheets 200b-200e thus may face surfaces of the battery modules 104b, 104d, 104f, and 104h, with an opposite side of the insulator sheets 200b-200e facing surfaces of the battery modules 104c, 104e, 104g, and 104i. The bus bar contacts 206 may generally sandwich or support the insulator sheets 200b-200e on either side. The insulator sheets 200b-200e may be spaced away from the modules 104b-104i by the bus bar contacts 206, thereby allowing ventilation from the battery modules 104b-104i, e.g., around the sides of the module 104b-104i and/or between a vent clearance between the modules 104 and the cover 116. A plastic barrier layer 207 may be positioned between the bus bar contacts 206, with the insulator sheets 200b-200e secured with one or more insulator clips 209. As seen in FIG. 11, there may be a plurality of insulative layers between adjacent modules 104. More specifically, the insulative clips 209 may generally cover around the busbar joints, and insulative covers 211 may electrically separate the busbars from adjacent components, e.g., crossmembers 106 (see FIG. 10) , to prevent shorting between the busbars and the battery pack frame. Terminals of the battery pack 100, e.g., positive/negative terminals (not shown) may be electrically connected to the busbar contacts 206. The insulative clips 209 may electrically isolate the busbar contacts 206, fasteners thereof, or the like with respect to other components and may also retain the insulator sheets 200b, 200c, 200d, and 200e in the vertical orientation between the modules 104.

Turning now to FIGS. 4, 5, and 11-23, an example process of assembling a battery pack for an electric vehicle, e.g., battery pack 100, is illustrated and described in further detail. Initially, a pack housing comprising one or more battery modules may be provided. For examples, as described above a plurality of battery modules 104a-i may be installed into bays of a pack housing defined by wall members 102, floor structure 114, and cross members 106. Subsequently, one or more insulator sheets may be installed into the battery pack 100.

One or more of the example insulator sheets may include vertically oriented insulator sheets. For example, insulator sheets 200b-200e may be installed in a vertical orientation, i.e., with the insulator sheets 200b-200e elongated in a vertical direction, within an aisle defined by the modules 104, as noted above.

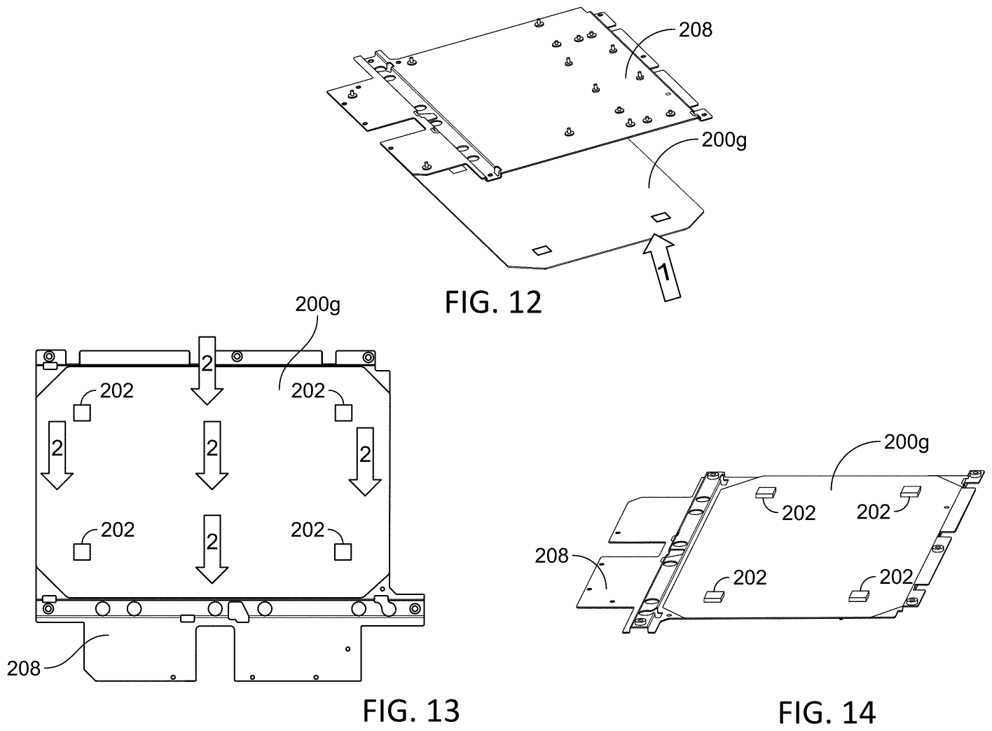

As illustrated in FIGS. 12-14, an insulator sheet 200g may be secured to a first backing layer 208, with standoffs 202 secured to the insulator sheet 200g, e.g., with an adhesive. An adhesive layer on the insulator sheet 200g allows the insulator sheet 200g to be secured to the backing layer 208, e.g., by an operator using hand pressure. In this example, the first backing layer 208 is formed of a metallic material. More specifically, the backing layer 208 is a power-coated sheet steel. An additional adhesive may couple the standoffs 202 to the insulator sheet 200g prior to or during installation of the insulator sheet 200g. As noted above, the standoffs 202 of the insulator sheet 200g may be compressed, e.g., due to weight of the sheet assembly 200a being installed over the insulator sheet 200g, and as such the insulator sheet 200g is generally held in position within the battery pack 100.

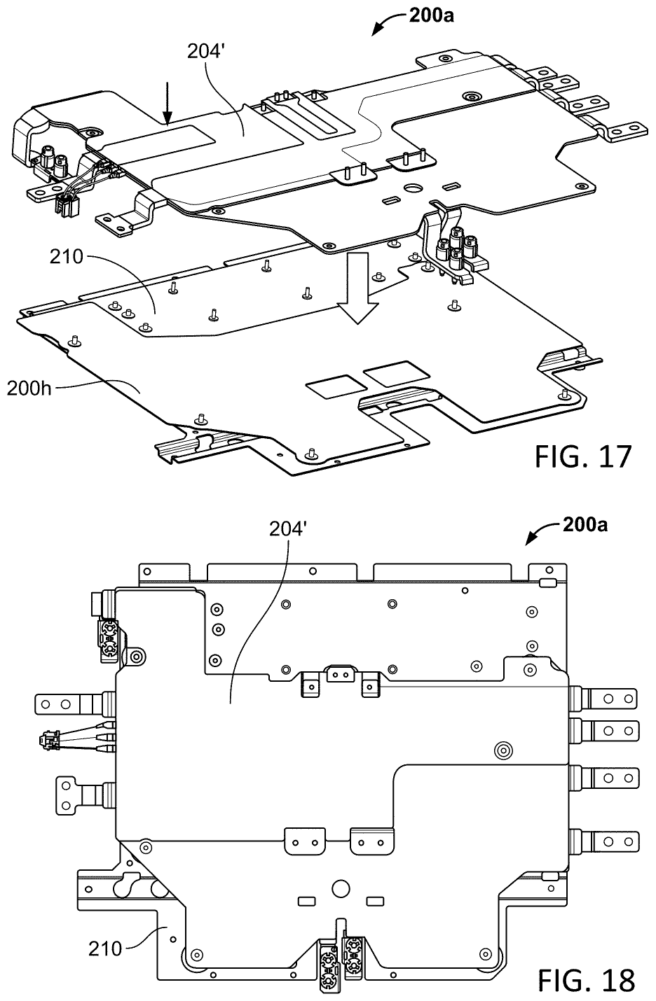

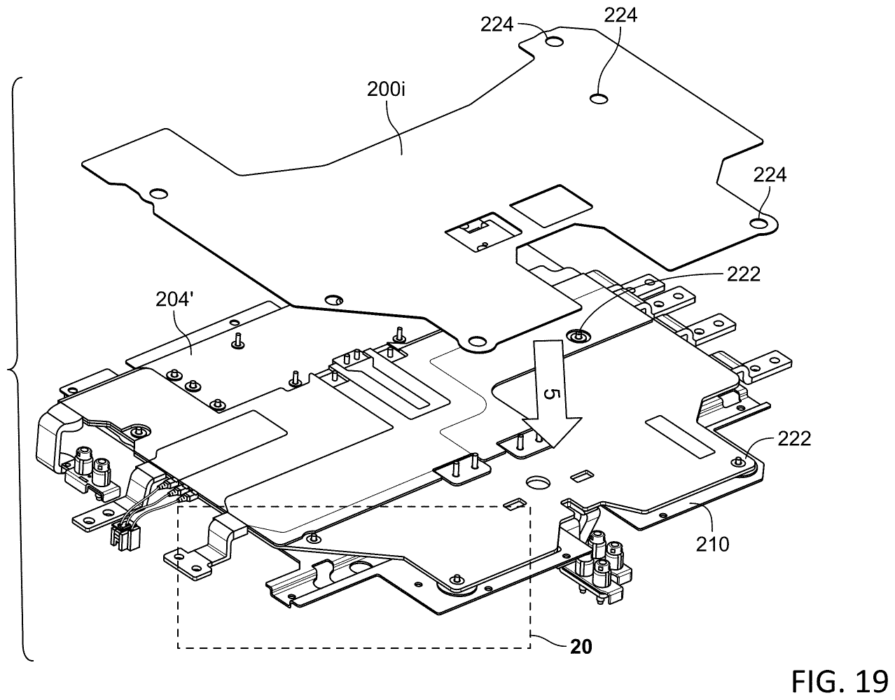

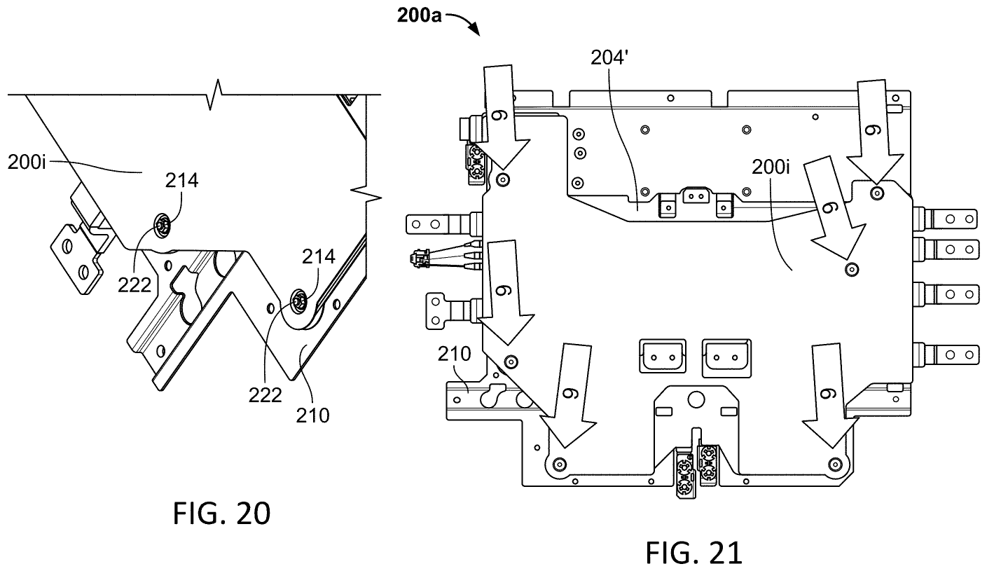

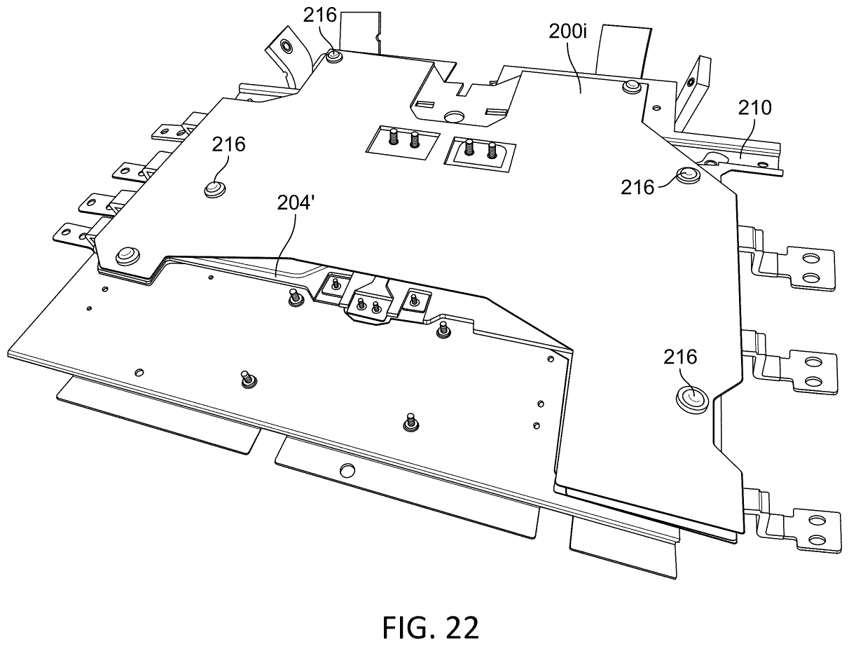

Turning now to FIGS. 15-22, multiple insulator sheets may be provided in a layered assembly, e.g., sheet assembly 200a. Initially, a second backing layer 210 is provided, onto which insulator sheet 200h is laid. As with the first backing layer 208, the second backing layer 210 may be formed of a metallic material, e.g., with the backing layer 210 having a sheet steel construction. The insulator sheet 200h may include a plurality of locating apertures 220, which are fit over locating studs 222 of the backing layer 210. Proceeding to FIGS. 17-18, laminated bus bar assembly 204′ may be positioned upon the insulator sheet 200h to form the sheet assembly 200a. As illustrated in FIGS. 19-20, an additional insulator sheet 200i may be laid over the laminated bus bar assembly 204′, with locating apertures 224 being positioned over the same locating studs 222 of the backing layer 210 as the insulator sheet 200h. Proceeding to FIGS. 20 and 21, nuts 214 may secure each of the insulator sheets 200h, 200i and the laminated bus bar assembly 204′ to the backing layer 210. Proceeding to FIGS. 21 and 22, insulating caps 216 may be installed to cover the nut 214/studs 222. The sheet assembly 200a may then be installed over the battery module 104a of the battery pack 100.

Any number or configuration of insulator sheets may be employed in the battery pack 100 that is convenient. For example, additional insulator sheets 200g (see FIG. 7) may be provided over one or more of the modules 104. Further, a rear insulator sheet 200f (see FIGS. 6 and 9) may be laid over upon the modules 104b-104i, as noted above.

A cover 116 may enclose the pack housing defined by the wall members 102, thereby enclosing the battery modules 104 within. Further, standoffs of the insulator sheets, e.g., standoffs 202′ of the insulator sheet 200f (see FIG. 9), and/or standoffs 202 of the insulator sheet(s) 200g, may support their respective insulator sheets away from associated modules 104 to provide a vent flow path therebetween. For example, as seen in FIG. 23, standoffs 202 may contact one or more of the modules 104, thereby spacing away an insulator sheet(s) 200 from upper surfaces 107 of the module(s) 104 and facilitating venting of the modules 104 into the space between. In this manner, standoffs 202 may define a vent flow path 113 for gases to vent from the modules 104, which may be subsequently directed out of the battery pack, e.g., through the pressure relief valves 108.

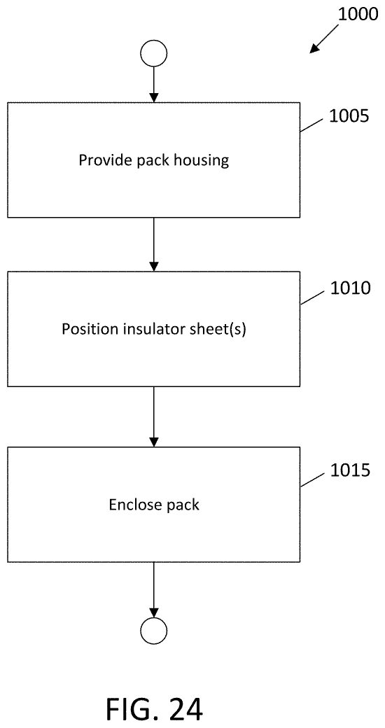

Referring now to FIG. 24, an example process 1000 for assembling a battery pack, e.g., for an electric vehicle, is illustrated and described in further detail.

Process 1000 may begin at block 1005, where a pack housing is provided that comprises one or more battery modules. For example, as noted above, a housing 101 may be established by a plurality of wall assemblies 102 and a floor structure 114, e.g., as illustrated in FIGS. 1 and 4. In at least some example approaches, multiple bays 105 may be formed within the housing that are configured to receive one or more battery modules 104. Process 1000 may then proceed to block 1010.

At block 1010, an insulator sheet may be positioned between the battery module(s) and the pack housing. Insulator sheets 200 are described above in various example configurations which may be employed depending on the needs of a given application. As noted above, in some examples each of the insulator sheet assembly 200a, insulator sheets 200b-200e, insulator sheet 200f, and insulator sheet 200g may be incorporated in a battery pack 100.

In an example employing each of the insulator sheets/assemblies 200a, 200b-e, 200f, and 200g, initially battery modules 104 may be positioned or installed in bays 105 of the housing 101, with one or more of the insulator sheets 200g positioned beneath, between, and/or on top of the modules 104. The insulator sheet(s) 200g, as also noted above, may include standoffs 202 which space away the insulator sheet 200g from an adjacent module 104, forming vent flow path(s) with the insulator sheet 200g and surface(s) of the battery module 104. Accordingly, a vent flow path may be defined extending between the insulator sheet 200g and the surfaces 107 of the battery module 104, e.g., as illustrated in FIG. 23.

Continuing with this example, vertically oriented insulator sheets 200b-200e may be subsequently be positioned between modules 104, e.g., within an aisle 250 formed by the positioning of the modules 104. These insulator sheets 200b-200e may each form vent flow paths with respect to adjacent modules 104, as described above. Further, the insulator sheet assembly 200a and the insulator sheet 200f may each be positioned on top of the modules 104. As noted above, the insulator sheet assembly 200a may include insulator sheets in a layered busbar assembly. The insulator sheet 200f may include standoffs 202′ spacing away insulator sheet 200f from surfaces 107 of adjacent battery modules 104. Process 1000 may then proceed to block 1015.

At block 1015, the pack may be enclosed. For example, as described above a battery pack 100 may have a housing 101 that is enclosed with a cover 116 (see FIG. 2). Process 1000 may then terminate.

The systems and processes discussed above are intended to be illustrative and not limiting. One skilled in the art would appreciate that the actions of the processes discussed herein may be omitted, modified, combined, and/or rearranged, and any additional actions may be performed without departing from the scope of the invention. More generally, the above disclosure is meant to be exemplary and not limiting. Accordingly, the bounds of the claimed invention(s) should be determined from the claims and is not limited by the present disclosure. Furthermore, it should be noted that the features and limitations described in any one embodiment may be applied to any other embodiment herein, and flowcharts or examples relating to one embodiment may be combined with any other embodiment in a suitable manner, done in different orders, or done in parallel. In addition, the systems and methods described herein may be performed in real time. It should also be noted that the systems and/or methods described above may be applied to, or used in accordance with, other systems and/or methods.

While some portions of this disclosure may refer to “convention” or examples, any such reference is merely to provide context to the instant disclosure and does not form any admission as to what constitutes the state of the art.

The foregoing description includes exemplary embodiments in accordance with the present disclosure. These examples are provided for purposes of illustration only, and not for purposes of limitation. It will be understood that the present disclosure may be implemented in forms different from those explicitly described and depicted herein and that various modifications, optimizations, and variations may be implemented by a person of ordinary skill in the present art, consistent with the following claims.

What is claimed is:

1. An insulator assembly, comprising:
an insulator sheet; and
an insulator sheet standoff coupled to the insulator sheet and configured to allow ventilation associated with the insulator sheet and one or more surfaces of a battery component.

2. The insulator assembly of claim 1, wherein the battery component is a module, and wherein the insulator sheet is spaced from the one or more surfaces of the battery module by the insulator sheet standoff to define a vent flow path therebetween.

3. The insulator assembly of claim 1, wherein the insulator sheet standoff is a compliant member configured to support the insulator sheet away from the one or more surfaces of the battery component in a compressed state.

4. The insulator assembly of claim 3, wherein the compliant member comprises a foam material.

5. The insulator assembly of claim 1, wherein the insulator sheet standoff is an electrical component of a bus bar configured to electrically connect the battery component to an electrical load of a vehicle.

6. The insulator assembly of claim 5, wherein the insulator sheet is configured to be aligned vertically between two adjacent battery modules.

7. The insulator assembly of claim 1, wherein the insulator sheet standoff is configured to support the insulator sheet against a backing layer.

8. The insulator assembly of claim 7, wherein the backing layer is a cover of a battery pack containing the battery component.

9. The insulator assembly of claim 7, wherein the backing layer is a metallic layer of a laminated bus bar assembly configured to electrically connect the battery component to an electrical load of a vehicle.

10. The insulator assembly of claim 1, wherein the insulator sheet standoff is coupled to the insulator sheet with an adhesive.

11. The insulator assembly of claim 1, wherein the insulator sheet comprises any one or more of nickel, steel, a high temperature mineral, or mica.

12. A battery pack for an electric vehicle, comprising:
a pack housing comprising a battery component;
an insulator sheet positioned between the battery component and the pack housing; and
an insulator sheet standoff coupled to the insulator sheet and configured to allow ventilation associated with the insulator sheet and one or more surfaces of the battery component.

13. The battery pack of claim 12, wherein the battery component is a module, and wherein the insulator sheet is spaced from the one or more surfaces of the battery module by the insulator sheet standoff to define a vent flow path therebetween.

14. The battery pack of claim 12, wherein the insulator sheet is a first insulator sheet, the battery pack further comprising a second insulator sheet layered with the first insulator sheet in a laminated bus bar assembly.

15. The battery pack of claim 14, wherein the first insulator sheet is positioned above a first battery component, and the second insulator sheet is arranged above a second battery component, the second insulator sheet adjacent a cover of the battery pack housing.

16. The battery pack of claim 12, further comprising a plurality of insulator sheets arranged in a vertical orientation between a plurality of battery components.

17. The battery pack of claim 12, wherein the insulator sheet standoff is configured to support the insulator sheet against a backing layer.

18. A method of assembling a battery pack for an electric vehicle, comprising:
providing a pack housing comprising a battery component;
positioning an insulator sheet between the battery component and the pack housing; and
enclosing the pack such that one or more insulator sheet standoffs coupled to the insulator sheet support the insulator sheet away from the battery component to provide a vent flow path therebetween.

19. The method of claim 18, wherein the battery component is a module, and wherein positioning the insulator sheet between the battery module and the pack housing forms a vent flow path with the insulator sheet and one or more surfaces of the battery module, the vent flow path extending between the insulator sheet and the one or more surfaces of the battery module.

20. The method of claim 18, further comprising positioning a plurality of insulator sheets between a plurality of battery components in a vertical orientation.
